(19) United States
(12) Patent Application Publication
(10) Pub. No.: US 2025/0197202 A1
(43) Pub. Date: Jun. 19, 2025

(54) SYNTHESIS OF NEW POLYMERS FOR THE MANUFACTURE OF SOLID HYDROGEN TRANSFER AGENTS

(71) Applicant: Instituto Mexicano del Petróleo, Mexico City (MX)

(72) Inventors: Emilio Leal Gómez, Mexico City (MX); León Pablo Torres Mancera, Mexico City (MX); Jorge Ancheyta Juárez, Mexico City (MX); Fernando Alonso Martínez, Mexico City (MX); Laura Olivia Alemán Vázquez, Mexico City (MX)

(21) Appl. No.: 18/982,066

(22) Filed: Dec. 16, 2024

(30) Foreign Application Priority Data
Dec. 15, 2023 (MX) MX/A/2023/015411

(51) Int. Cl. C01B 3/00; B01J 20/26; C08G 10/00

(52) U.S. Cl. CPC C01B 3/0078; B01J 20/262; C08G 10/00

(57) ABSTRACT

This disclosure refers to a method for the synthesis of polymers with weight average molecular weights greater than 50,000 g/mol, chemically inert, with a minimum decomposition temperature of 425° C., and a main chain composed only of carbon-carbon bonds, which contain structures of the type of naphthalene, phenanthrene, anthracene, pyrene, carbazole or any other where two or more aromatic rings of six carbon atoms of the benzene-type are fused, which may or may not contain aromatic heterocycles. In addition, the polymers obtained from the present disclosure may or may not contain fluorine atoms in their structure. The synthesis described here is carried out by means of polycondensation between a polycyclic aromatic compound and a compound with a carbonyl group in its structure in a strong acid medium.

### CROSS-REFERENCE TO RELATED APPLICATIONS

This patent application claims priority under 35 U.S.C. Section 119 to Mexican Patent Application No. MX/a/2023/015411, filed Dec. 15, 2023, the entire disclosure of which is incorporated herein by reference.

### FIELD

The present disclosure relates to the chemistry field, specifically polymer synthesis and it refers to a procedure for the obtention of polymers that contain chemical structures of the type of naphthalene, phenanthrene, anthracene, pyrene, carbazole, or mixtures thereof; and any other where two or more aromatic rings of six members of the benzene type are fused together.

### BACKGROUND

The main issues in the deep hydrotreating processes are the limited availability of reactive hydrogen atoms in the core of the reaction, the usage of high hydrogen partial pressures, and the high hydrogen consumption of the process. An alternative solution to the hydrogen gas partial pressures increase to raise the quantity of reactive hydrogen atoms in the hydrotreating is the application of liquid hydrogen donors. Liquid hydrogen donors are polyaromatic hydrocarbons with two or more fused aromatic rings in their structure, these compounds must be partially or fully hydrogenated previously to usage. Said hydrogenated compounds are capable of provide an additional quantity of hydrogen atoms in the core of the reaction and, subsequently, they can maintain a hydrogenation-dehydrogenation equilibrium, therefore, favoring the hydrogenation of aromatic hydrocarbons, nitrogen, and refractory sulfur compounds present in the feedstock and moderating hydrogen partial pressure and hydrogen consumption. So, the hydrogenation of such compounds contributes to the elimination of the sulfur and nitrogen impurities in the refractory compounds. Some examples of liquid hydrogen donors are the hydrogenated derivatives of naphthalene:decaline and tetraline. It has been reported that the application of hydrogen donors in hydrotreating has the benefits of lowering the quantity of coke deposited on the catalyst surface during the process, thus, avoiding a premature deactivation, and in the case of the heavy and extra-heavy crude oil upgrading and distillation residues, increasing the yield of distillates with higher added value. Additionally, the application of the hydrogen donor solvents in carbon liquefaction for the production of liquid hydrocarbons shows similar benefits. However, hydrogen donors of this type are expensive and their recovery and separation from the products is difficult, as a consequence of their high miscibility and similar boiling points. For those reasons, their application in industrial processes is limited and this has led to the development of heterogeneous hydrogen donors, as described in Alemán-Vázquez, L. O.; Torres-Mancera, P.; Ancheyta, J.; Ramírez-Salgado, J. Energy Fuels, 30 (11), (2016) 9050-9060.

Some technological developments related to liquid hydrogen donors are mentioned as follows.

U.S. Pat. No. 3,413,212 A refers to a method of hydrocracking with an aluminosilicate crystalline catalyst in presence of a liquid hydrogen donor, in a range of operating temperatures from 289 to 593° C., of hydrocarbon cuts with a boiling point higher than 204° C., with the objective of obtaining hydrocarbon fraction with boiling points in the gasoline range. The utilized hydrogen donor in said process contains partially or fully hydrogenated polycyclic aromatic compounds with a boiling point from 204 to 482° C., preferably 1,2,3,4-tetrahydronaphthalene (tetraline) and decahydronaphthalene (decaline).

U.S. Pat. No. 4,210,518 A presents an upgraded method for the carbon liquefaction or similar carbonaceous solids that utilizes a liquid hydrogen donor for obtaining a liquid hydrocarbon with lighter molecular weight.

U.S. Pat. No. 4,294,686 A describes an integrated upgrading process of heavy and highly viscous crude oil for the decrease in its specific gravity, viscosity and range of boiling temperatures. In said disclosure the heavy and viscous crude oil is fractionally distilled and the residuum is treated with a liquid hydrogen donor under hydrocracking conditions. The hydrogen donor solvent is fractionally distilled in the temperature range between 180° C. and 350° C., it is hydrogenated again and recycled to the hydrocracking zone.

U.S. Pat. No. 4,363,716 A refers to a liquefaction catalytic process of carbonaceous feed material into lower molecular weight liquid hydrocarbons in the presence of a hydrogen donor solvent containing at least 0.6 weight percent in donatable hydrogen and a gas with high hydrogen content in the liquefaction zone.

U.S. Pat. No. 4,345,989 A discloses a process involving a hydrogen donor solvent for the upgrading of heavy liquid hydrocarbons with a melting point below 250° C. for the obtention of lighter products. The reaction mixture is heated at a temperature range between 250 to 800° C. for a time range of 15 seconds to 5 hours, subsequently the hydrogen donor solvent is recovered in a temperature range from 175 to 300° C., it is hydrogenated in the presence of a metallic catalyst and recycled in the cracking zone. Said hydrogen donor solvent is a middle distillate fraction that may contain at least 30% in weight of hydroaromatic compounds of 2 rings, which are constituted for 10 to 20 carbon atoms per molecule.

The Canadian Patent CA 1,144,501 A refers to a process for upgrading heavy crude oils by mixing the heavy crude oil with a hydrogen donor diluent and the mixture undergoes thermal cracking for yielding higher value hydrocarbons. The products of the thermal cracking are then divided into 3 fractions, a light end vapor fraction, an intermediate gas oil fraction, and a pitch fraction. A part of the gas oil fraction is hydrogenated to produce the hydrogen donor diluent again.

U.S. Pat. No. 4,395,324 A describes an improvement of the process of thermal cracking of heavy crude oil with a hydrogen donor diluent, in the absence of catalyst and under hydrogen atmosphere. The improvement refers to the hydrogen donor diluent, which is retrieved through the extraction with naphtha from the product of the thermal cracking of a heavy crude oil and its subsequent hydrogenation from a hydrogen donor with lower boiling point, like tetraline, for its recycling. In this disclosure, the improved hydrogen donor diluent is the heavy hydrocarbon fraction treated by thermal cracking in the absence of catalyst that was separated by the addition of naphtha. Such fraction is a cut with a high content of polyaromatic compounds with a boiling point above 316° C. and contains species such as pyrene, fluoranthrene, nitrogen heterocycle compounds, among others. On the other hand, naphtha has a boiling point inside the range of 30 to 220° C. and is constituted mainly by naphthalene and alkyl-naphthalene. It was reported that the hydrogen donating ability of the heavier polyaromatic fraction is higher than the hydrogen donation ability of the lighter conventional hydrogen donors, such as naphthalene, tetraline, and decaline. Therefore, tetraline is used to manufacture the improved hydrogen donor by extracting and hydrogenating the heavier polyaromatic hydrocarbons fraction from the thermal cracking products.

U.S. Pat. No. 4,485,004 A describes a process in which a heavy hydrocarbon is converted into lighter products via catalytic hydrocracking in the presence of a hydrogen donor liquid at a temperature range from 400 to 450° C. In this disclosure, the hydrogen donor is a light cycle oil with a boiling point range between 200 to 300° C. and the catalyst contains cobalt, molybdenum, nickel, tungsten, and mixtures thereof.

U.S. Pat. No. 7,594,990 B2 describes a process in which a hydrogen donating solvent is employed to maximize the resid conversion and the conversion rate in an ebullated bed resid hydrocracker. In this disclosure, the hydrogen donor precursor is made from in-situ hydroreforming reactions, it is recovered as the resin fraction of a deasphalting unit, it is regenerated by hydrotreating, and it is recycled to the ebullated bed hydrocracker. The main advantages of the disclosure are the higher efficiency in the hydrogen donating solvent regeneration in the separate hydrotreating unit and the slowing of the formation of coke precursors by the hydrogen donor.

Chinese Patent CN 103,923,694 B refers to a method for the obtention of gasoline by the mixing of coal tar with a hydrogen donor solvent in the presence of a hydrogenation catalyst to perform a hydrocracking reaction and produce gasoline. In this patent, the hydrogen donor is a petroleum fraction with a boiling point ranging from 200 to 538° C. The operating conditions are inside the ranges of 300 to 470° C. of temperature and of 3 to 19 MPa of pressure. Yields of 85 to 96% were reported for the hydrocarbons fraction with a boiling point smaller than 350° C. in the product. The equipment and operation are simple, so the manufacturing cost of gasoline is significantly reduced.

U.S. Pat. Application No. 2020/0270530 A1 details a process for treating high viscosity hydrocarbons with hydrogen donor solvents. Said application refers to hydrogen donors as a stream derived from petroleum with a high content of hydroaromatics, hydrotreated derivatives of coal liquefaction products, liquefied hydrotreated lignin derivatives, or any non-aromatic cycle of carbon atoms with one or more double bonds, conjugated double bonds in unsaturated fatty acids, an acid dimer, processed pine wood and/or an oil product of catalytic hydrothermolysis.

The patents previously mentioned refer to the usage of liquid hydrogen donors for hydrotreating, coal liquefaction, and heavy and extra-heavy crude oil upgrading, or residues of the petroleum fractional distillation. However, it has been observed that liquid hydrogen donors are expensive and hardly separated from the products, as a consequence of their high miscibility and similar boiling points with petroleum products. Therefore, a proposed alternative has been the application of heterogeneous hydrogen donors. In a similar manner to the liquid hydrogen donors, the heterogenous hydrogen donors or solid hydrogen transfer agents are materials capable of providing reactive hydrogen and stay in a hydrogenation-dehydrogenation equilibrium while remaining in solid state when they are subjected to moderate hydrotreating conditions, so that they increase the availability of dissociated hydrogen atoms in the core of the reaction and favor hydrogenation reactions. In such a way that solid hydrogen transfer agents do not show the same issues as liquid hydrogen donors because they have a higher chemical stability and remain in solid state under the operating condition of hydrotreating, in the temperature range of 100 to 450° C., hence they are easily recovered and recycled.

U.S. Pat. No. 4,642,175 A refers to a method for reducing formed coke during catalytic and thermal cracking processes in absence of hydrogen of heavy crude oils by contacting them with a free radical eliminating catalyst. Said catalyst may be heterogeneous or homogeneous, it is composed of naphthenate salts and a transition metal and works preferably at temperatures under 350° C. It is proposed that the catalyst acts as an intramolecular and intermolecular hydrogen carrier that stops the proliferation of free radicals.

U.S. Pat. No. 9,862,658 B2 patent refers to the use of solid polymers and copolymers of the polyester-type with naphthalene-type units in their structure, namely, with 2 or more fused aromatic, alicyclic or heterocyclic rings, as solid hydrogen transfer agents for hydrogenation reactions of organic compounds. Because they are solids in the temperature range of 100 to 450° C., these solid hydrogen transfer agents can be readily recovered and reutilized. Said polymers may or may not be supported over metallic oxides, such as alumina, boehmite, silica, titania, kaolin, and mixtures thereof, and may or may not be used alone or combined with metallic catalysts in the hydrogenation reactions.

U.S. Pat. No. 10,077,334 B2 describes a method for the application of solid polymers or copolymers manufactured from monomers that have polycyclic aromatic rings in their structure, in the hydrotreating or hydrocracking of heavy hydrocarbons, such as heavy and extra-heavy crude oils and petroleum distillation residues. Said solid hydrogen transfer agents may be polymers and copolymers of the type of polyester, polyether, polyamide or polyvinyl that contain polyaromatic structures in their structure and have a decomposition temperature higher than 450° C. In the examples of the patent the used heterogeneous hydrogen donors are of the polyester-type with naphthalene in their structure, which are hydrogenated prior to their application, so they possess available hydrogen to donate during the reaction. It was reported that these hydrogen donors upgrade the crude oils properties, such as API gravity, viscosity and distillates proportion; moreover, they prevent coke formation.

U.S. Pat. No. 10,793,784 B2 discloses a procedure for the manufacturing of improved solid hydrogen transfer agents from a polymer with units of naphthalene, phenanthrene or anthracene, which present the capacity of hydrogen donation in any reduction and hydrotreating chemical reaction. The methodology claimed in this patent indicates that the grinding of boehmite, SiO₂, Al₂O₃, kaolin, or mixtures thereof, followed by the addition of distilled water, stirring of the mixture until it generates a paste, addition of solution of nitric acid at 5 vol. %, mixing of the resulting gel with the hydrogen donating polymer, extrusion, drying, and activation of the material in a continuous reactor with flux of hydrogen gas of 100 to 150 mL/min at a pressure of 40 to 70 kg/cm² and temperature ranging from 100 to 500° C.

U.S. Pat. No. 10,745,629 B2 refers to a process of upgrading of heavy petroleum and/or vacuum residuum of the petroleum distillation to produce liquid transport fuels using plastic residues as hydrogen donor agents. The process involves mixing the plastic residues with the heavy crude oil in a range of ratios of 1:1 to 4:1 in weight, respectively, in a batch reactor. Subsequently, preheating in a temperature range of 130 to 220° C. for 20 to 30 minutes, the preheated mixture is then heated until a temperature of 390 to 420° C. and a pressure range from 40 to 100 kg/cm² with hydrogen gas for 30-90 min. The plastic residue used was obtained from packing plastics. The hydrodemetalation and hydrocracking conversions of vacuum residuum are of 97 and 84 wt, %, respectively.

Some other Mexican patents related to solid hydrogen transfer agents are described as follows, highlighting the differences between them and the disclosure of the current application.

Mexican patent No. MX/a/2014/013477 claims the use of polymers or copolymers of the polyester-type with units of naphthalene as solid hydrogen transfer agents in hydrogen transfer reactions. It also describes the synthesis of these polymers or copolymers of the polyester-type as a two-step process, wherein the first step involves the acetylation of the 1,5-dihidroxynaphthalene and the second step is the polymerization of the 1,5-diacetoxynaphthalene with dicarboxylic acids inside an autoclave reactor of stainless steel at conditions of 275-350° C. under nitrogen atmosphere. The present disclosure describes the synthesis of polymers that contain structures such as naphthalene, phenanthrene, anthracene, pyrene, or any other where 2 or more aromatic rings of 6 carbon atoms of the benzene-type are fused and the main chain of said polymers is only comprised of carbon-carbon bonds; therefore, they are not polyester-type polymers. Additionally, the method of synthesis of the polymers of the current disclosure is by means of the polyhydroxtalkylation reaction, which can be performed in a one-step process with a superacid catalyst, at room temperature, atmospheric pressure and an air atmosphere, and it allows the use of polyaromatic reactants (with 2 or more fused aromatic rings) such as anthracene, phenanthrene, pyrene, carbazole, among others, along with a reactant with a carbonyl group (which may or may not be fluorinated) without the necessity of any pretreatment to the reactants. For those reasons the method for the synthesis of polymers of the present patent cannot be deducted from this previous patent.

Mexican patent No. MX/a/2015/010173 refers to the application of polymers and copolymers manufactured from monomers that contain in their structure a polycyclic aromatic ring, an aromatic ring of the naphthalene-type, or naphthalene units in their structure, or of polyester, polyether, polyamide or polyvinyl derivatives for the hydrotreating or hydrocracking of heavy hydrocarbons, such as heavy of extra-heavy crude oil and petroleum distillation residuum, these polymers and copolymers may or may not be supported, or in physical mixture, with metallic oxides such as alumina, silica, titania or kaolin. In the claims of the disclosure a method for the hydrotreating (hydrocracking) of heavy crude oils is mentioned, which comprises the presence of at least a hydrogen donor with at least a polymer like the one previously described. The synthesis procedure that is described in the text of the patent and the examples is related to the patent MX/a/2014/013477, therefore, in the same way it can be stated that the present disclosure cannot be deducted from the Mexican patent No. MX/a/2015/010173.

Mexican patent application No. MX/a/2017/009054 refers to a manufacturing procedure of the solid hydrogen transfer agents (SHTA), which contain a polymer with units like naphthalene, phenanthrene or anthracene. The disclosure claims include the manufacturing procedure of the SHTA from said polymers and metallic oxides, such as boehmite, silica, alumina, among others, and an upgrading process of heavy and extra-heavy crude oils or residuum that involves mixing the feedstock with a SHTA at specific operating conditions. However, nowhere in the patent application a polymer synthesis procedure is described for the polymers used to manufacture the SHTA. The current disclosure claims a method of synthesis for new polymers from which the improved SHTA can be manufactured using the procedure described in said patent application. It is noteworthy that the present disclosure cannot be deducted from said patent application because the innovation described in the claims is the method of synthesis of the new polymers, not the SHTA manufacturing neither their applications. Additionally, this type of polymers is not previously reported in any patent of scientific paper.

Finally, Mexican patent application No. MX/a/2022/013720 refers to the application of heterogeneous hydrogen donors of SHTA made from a polymer that contains in its structure units like naphthalene, phenanthrene, anthracene, that may or may not be supported, anchored or physically mixed with metallic oxides such as alumina, silica, titania or kaolin and/or mixtures thereof, for using them along with hydrodesulfurization (HDS) catalysts in multi-bed configurations to produce ultra-low sulfur diesel (ULSD) or not ULSD, and/or streams derived from petroleum and/or mixtures thereof, such as straight-run gas oil, kerosine, jet fuel, naphta, etc. So, in a similar way to the Mexican patent No. MX/a/2015/010173, this patent application (MX/a/2022/013720) claims the application of the SHTA, and in this case in the claims a process for the production of ULSD with a stacked bed involving an HDS catalyst and a SHTA is mentioned. Furthermore, a process for the manufacturing of the SHTA from a polymer and a metallic oxide is detailed, however, similarly as patent application No. MX/a/2017/009054, nowhere in the text is described a method of synthesis for the polymers. Therefore, the present disclosure cannot be deducted from this patent application.

The previously mentioned patents refer to the utilization of solid materials as heterogeneous hydrogen transfer agents in hydrogenation and heavy and extra-heavy crude oils, and/or vacuum residuum of petroleum distillation upgrading. In the cases where the solid hydrogen donor was synthesized (namely, the polymer or copolymer), the synthesized polymer was of the polyester-type with units of two fused aromatic rings in their structure, however, this type of polymers because they have heteroatoms comprising the main polymer chain can be sensitive to hydrogenation, which may cause the decreasing in size of the polymeric chain previous to the agent application, also known as activation. Other polymeric materials used as hydrogen donors in previous disclosures are mixtures of distinct polymers or oligomers, and the detailed description of their chemical structures is missing.

The present disclosure has the advantage of producing polymers in which the main polymeric chain is comprised of only carbon-carbon bonds, which improves their chemical stability and makes them more compatible with the hydrocarbons that constitute the petroleum and its derivatives. Additionally, the polymer synthesis method by the polyhydroxyalkylation reaction is very flexible and allows using monomers that may contain fluor atoms or not and polyaromatic monomers without the need of pretreatments, for example, anthracene, phenanthrene, pyrene, fluoranthene, carbazole, among others. Furthermore, the tunning of reaction conditions (reactants, time, and quantity of the catalyst) allows control over the degree of cross-linking of the polymeric chains and, therefore, the polymer properties, such as hydrogen donating ability, decomposition temperature, solubility and mechanical properties. These characteristics of the methodology disclosed in the current disclosure are highly relevant because due to them, hydrogen donor polymers can be easily designed and synthesized for specific applications, since not all synthesized polymers will show the same properties, hydrogen donating ability, or optimal functioning conditions (reversibility of the hydrogenation-dehydrogenation reaction). Research aimed determining the polyaromatic compounds with higher hydrogen donating ability by calculations of the density functional theory, transition state theory and algorithms, have concluded that the hyperconjugation and ring strain play essential roles in the hydrogen donating ability of the donors. In addition, it has been observed that hydroaromatic compounds have higher hydrogen donor abilities than cycloalkanes with the same carbon structure and 5-carbon rings have a lower ability to donate hydrogen than 6-membered rings due to their greater ring strain (Hou, P.; Zhou, Y.; Guo, W.; Ren, P.; Guo, Q.; Xiang, H.; Li, Y. W.; Wen, X. D.; Yang, Y. Energy Fuels, 32 (4), (2018) 4715-4723; Bai, J. K.; Zhang, X. B.; Li, W.; Wang, X. B.; Du, Z. Y.; Li, W. Y. Fuel, 318, (2022) 123621).

The following are the previous patents related to the polymerization method described in the present disclosure.

U.S. Pat. No. 7,771,857 B2 mentions a method for the synthesis of polymeric electrolyte membranes consisting of monomeric units with aromatic polyarylene groups and functional groups capable of conducting protons attached to them. In this method, aromatic polyarylene, which may be biphenyl or terphenyl, is added along with a trifluorinated phenyl ketone and a strong acid, such as trifluoromethanesulfonic acid, under stirring for 24 to 72 h. This method has the advantage of obtaining polymers without ester, ether, ketone, or sulfone groups, which can be processed to produce mechanically stable films resistant to oxidation and hydrolysis.

U.S. Pat. No. 10,189,948 B2 details a method for synthesizing copolymers with intrinsic microporosity through a polymerization reaction between isatin and fluorene-type aromatic ring compounds with various substituents, which was catalyzed by trifluoromethanesulfonic acid.

U.S. Pat. No. 11,236,196 B2 details the synthesis of a new class of polymers with superior mechanical properties and greater chemical stability compared to known polymers. These polymers are especially suitable for the usage as anion exchange membranes in fuel cells. The method for forming polymers involves reacting an aromatic compound and a trifluoroalkyl ketone in the presence of a strong acid to form a brominated alkyl precursor polymer and reacting the precursor polymer with a trialkylamine and sodium hydroxide to obtain a polyarylene with a main chain free of ether bonds.

U.S. Pat. No. 11,248,073 B2 refers to the apparatus and processes for manufacturing polymers of thiophenes, benzothiophenes, and their alkylated derivatives, which consist of isolating sulfur-containing heterocyclic hydrocarbons from cracked naphtha and making them react with a superacid to form polymers.

Mexican Patent Application No. MX/a/2020/010584 describes a procedure for synthesizing high-purity fluorinated bisphenols for use as monomers in polymerization reactions. This procedure is carried out by means of a hydroalkylation reaction with chlorinated solvents between phenolic compounds, fluorinated carbonyl compounds, and methanesulfonic acid is used as the catalyst under ambient pressure and room temperature conditions for 6 to 8 hours. This patent application mentions that polymers containing carbon and fluorine atoms in a greater proportion than other elements in their structure are known as fluoropolymers or fluoroplastics. Aromatic fluoropolymers have the following properties: high melting points (>360° C.) and high thermal and chemical stability.

The previously described patents refer to methods for synthesizing high-molecular-weight polymers, with improved mechanical properties and greater chemical and thermal stability, through reactions of aromatic compounds and compounds with ketone or aldehyde groups, which may or may not contain fluorine atoms in their structure, catalyzed by superacids. Similarly, the polymers synthesized using the methodology described here possess weight average molecular weights higher than those synthesized by conventional polycondensations (>50000 g/mol), are chemically inert, and have a minimum decomposition temperature of 425° C. Therefore, the polymers obtained by the method described here for the manufacture of optimized solid hydrogen transfer agents present advantages over the solid hydrogen transfer agents mentioned in the background, for example, higher average molecular weight, flexibility in choosing the polyaromatic unit in the synthesis, a polymer main chain free of ester, ether, amide, sulfone bonds, among other groups with heteroatoms, and greater capacity for hydrogen donation. Additionally, the presence of fluorine atoms in their chemical structure improves their thermal stability.

The methodology described here is based on the polyhydroxyalkylation reaction studied in the scientific articles Colquhoun, H. M.; Zolotukhin, M. G.; Khalilov, L. M.; Dzhemilev, U. M. Macromolecules, 34 (4), (2001) 1122-1124; Diaz, A. M.; Zolotukhin, M. G.; Fomine, S.; Salcedo, R.; Manero, O.; Cedillo, G.; Velasco, V. M; Guzman, M. T.; Fritsch, D.; Khalizov, A. F.; Macromol. Rapid Commun., 28 (2), (2007) 183-187; Guzman-Gutierrez, M. T.; Nieto, D. R.; Fomine, S.; Morales, S. L.; Zolotukhin, M. G.; Hernandez, M. C. G.; Kricheldorf, H.; Wilks, E. S. Macromolecules, 44 (2), (2011) 194-202; Cetina-Mancilla, E.; Olvera, L. I.; Balmaseda, J.; Forster, M.; Ruiz-Trevino, F. A.; Cardenas, J.; Vivaldo-Lima, E.; Zolotukhin, M. G. Polym. Chem., 11 (38), (2020) 6194-6205. Said type of polymerization is a polycondensation of the A₂+B₂ type, which does not follow the conventional mechanism of this type of polymerizations and, due to the atypical mechanism of this reaction, it is possible to overcome some of the problems related to conventional polycondensations, such as molecular weight limitation, high polydispersity indexes, and polymer chain cyclization. This reaction, like the hydroxyalkylation, involves a reactant with aromatic character, a reactant containing a carbonyl group in its structure, aldehyde, ketone, or carboxylic acid, and a superacid catalyst, trifluoromethanesulfonic acid. The polymerization is favored because after the previously described reaction, the diarylated product can continue reacting with another carbonyl group and so on.

### SUMMARY

The present disclosure corresponds to the chemistry field, specifically polymer synthesis and it refers to a procedure for the obtention of polymers that contain chemical structures of the type of naphthalene, phenanthrene, anthracene, pyrene, carbazole, or mixtures thereof; and any other where two or more aromatic rings of six members of the benzene type are fused together. The synthetized polymers from the methodology here described have average molecular weights by weight above 50000 g/mol, are chemically inert, and show a minimum decomposition temperature of 425° C. Furthermore, the synthesized polymers from this methodology are made of a main chain of carbon-carbon bonds free from other types of bonds, such as amide, ester, ether, among others; and may or may not contain fluor atoms on their structure. The polymers obtained from the current disclosure can be used for the manufacture of solid hydrogen transfer agents that may or may not be supported over metallic oxides, such as alumina, boehmite, silica, titania, kaolin and mixtures thereof. The solid hydrogen transfer agents manufactured from the polyaromatic polymers of the present disclosure may be applied to any reaction of hydrogenation or reduction of organic compounds, as well as reactions of hydrotreating of liquid hydrocarbons, upgrading of heavy and extra-heavy crude oil, atmospheric residue, vacuum residue, and petroleum fractions in presence or absence of catalyst, such as reactions of hydrodesulfuration, hydrodenitrogenation, hydrocracking, hydrodesoxygenation, hydrodemetallization, and hydrogenation.

The polymers obtained from this method have a main chain free of ester, ether, amide, sulfone bonds, among other groups with heteroatoms, which increases their chemical stability and makes them more compatible with the hydrocarbons that make up petroleum and its derivatives. In addition, it allows the use of reactive polyaromatic monomers without the need for preparation or pretreatment.

The polymers obtained from the procedure described here can be used for the manufacture of optimized solid hydrogen transfer agents that may or may not be supported on metallic oxides, such as alumina, boehmite, silica, titania, kaolin and mixtures thereof. The polymers can form composite materials with metallic oxides in order to improve their mechanical, thermal and textural properties. These optimized solid hydrogen transfer agents can be used alone or in combination with catalysts in hydrotreating processes of liquid hydrocarbons, improving the properties of heavy and extra-heavy crude oils, and/or petroleum distillation residuum, as well as in any hydrogenation or reduction reaction.

Various aspects of the present disclosure are also addressed by the following Paragraphs 1-13 and in the noted combinations thereof, as follows:

Paragraph 1: A method for synthesis of polymers for manufacturing of solid hydrogen transfer agents, said method comprising:
Step 1: weighing a first compound comprising a polycyclic aromatic compound and a second compound comprising a compound with a ketone, aldehyde or carboxylic acid functional group that may or may not contain fluorine atoms in its structure, with a ratio in the range of 1:1-1:1.5 mol with an excess of the second compound with a ketone, aldehyde or carboxylic acid functional group;
Step 2: adding the first and second compounds of step 1 as reactants to a reactor vessel;
Step 3: adding an organochlorinated solvent and continuously stirring until the reactants are dissolved, thereby yielding a reaction mixture of Step 3, wherein the organochlorinated solvent is selected from the group consisting of dichloromethane and chloroform, wherein the organochlorinated solvent is added in a ratio in the range of 1 mL-5 mL of solvent per gram of reactants, or in a ratio of 3 mL of solvent per gram of reactants;
Step 4: adding a strong acid catalyst, wherein the strong acid catalyst may optionally comprise a superacid catalyst selected from the group consisting of trifluoromethanesulfonic acid and trifluoroacetic acid, to the reaction mixture of Step 3 under stirring, at low to moderate temperatures, 5-50° C., preferably 10-30° C., under air or nitrogen atmosphere and at atmospheric, vacuum or low pressure, 1-5 bar, preferably atmospheric pressure, thereby yielding a reaction mixture of Step 4;
Step 5: maintaining continuous stirring of the reaction mixture of Step 4 for a time in the range of 2-48 hours, preferably 12-36 hours for non-stoichiometric reagent proportions and 4-24 hours for stoichiometric reagent proportions, thereby yielding a reaction mixture of Step 5;
Step 6: pouring the reaction mixture of Step 5 into methanol under continuous stirring, wherein the methanol volume is in excess, in a range of ratios of 5:1 to 20:1 in proportion to the solvent to terminate the reaction and precipitate the resulting polymer to yield a solid polymer;
Step 7: filtrating the solid polymer at vacuum and washing with methanol, and subsequently leaving it to dry for 12 to 24 hours at room temperature; and
Step 8: purifying the solid polymer by means of extraction with hot methanol in continuous reflux at boiling point temperature for 12 to 48 hours.

Paragraph 2: The method according to Paragraph 1, characterized by having weight average molecular weights higher than 50000 g/mol, chemically inert, minimum decomposition temperature of 425° C., and a main chain composed only by carbon-carbon bonds, which contain chemical structures of the type of naphthalene, phenanthrene, anthracene, pyrene or any other where two or more aromatic rings of six carbon atoms of the benzene type are fused, which may or may not contain aromatic heterocycles; additionally, the synthesized polymers may or may not contain fluorine atoms in their structure.

Paragraph 3: The method according to Paragraph 1, wherein the synthesized polyaromatic polymer has a main polymeric chain of carbon-carbon bonds free of ester, ether, amide, sulfone, among other functional groups with heteroatoms.

Paragraph 4: The method according to Paragraph 1, wherein in Step 1, the polycyclic aromatic compound is a polyaromatic hydrocarbon, which may or may not contain aromatic heterocycles selected from the group consisting of naphthalene, anthracene, phenanthrene, pyrene and carbazole and their substituted derivatives, or mixtures thereof.

Paragraph 5: The method according to Paragraph 1, wherein in Step 1, the compound with a carbonyl group in its chemical structure is an organic compound with at least one functional group of ketone, aldehyde or carboxylic acid, and do not contain fluorine atoms in its structure, said organic compound optionally being selected from the group consisting of benzaldehyde, 3-cyclohexene-1-carboxaldehyde, benzoic acid and their substituted derivatives, or mixtures thereof.

Paragraph 6: The method according to Paragraph 1, wherein in Step 1, the compound with a carbonyl group in its chemical structure is an organic compound with at least one functional group of ketone, aldehyde or carboxylic acid, and contains fluorine atoms in its structure, said organic compound optionally being selected from the group consisting of 2,2,2-trifluoroacetophenone, fluoroacetone, hexafluoroacetone, 1,1,1-trifluoroacetone, and their substituted derivatives, or mixtures thereof; and therefore, show improved thermal stability.

Paragraph 7: The method according to Paragraph 1, wherein in Step 1, the polycyclic aromatic compound is in a range of proportions with the compound with carbonyl group of 1:1 to 1:1.5 in mol, respectively, or 1:1.2 to 1:1.4 in mol, respectively.

Paragraph 8: The method according to Paragraph 1, wherein in Step 4, the strong acid catalyst is optionally a superacid selected from the group consisting of trifluoromethanesulfonic acid, trifluoroacetic acid, sulfuric acid and methanesulfonic acid, or mixture thereof.

Paragraph 9: The method according to Paragraph 1, wherein in Step 8, the purification of the solid polymer is by means of the continuous extraction with hot methanol, ethanol, or acetone, among others, for a time range of 12 to 48 hours, additionally involving one or more reprecipitations with a adequate pair of solvents selected from the group consisting of chloroform, dichloromethane, tetrahydrofuran, and mixtures thereof, and methanol, ethanol, and mixtures thereof.

Paragraph 10: A material of a solid hydrogen transfer agent type containing one or more of the polymers synthesized by the method according to Paragraph 1.

Paragraph 11: The material according to Paragraph 10, wherein said material may or may not be supported over metallic oxides, and may be used alone or in combination with catalysts in hydrotreating processes of crude oil and/or any of the fraction and derivatives obtained from it, as well as in any hydrogenation reaction or reduction of organic compounds.

Paragraph 12: The material according to Paragraph 11, wherein the metallic oxides are selected from the group consisting of alumina, boehmite, silica, titania, kaolin and mixtures thereof.

Paragraph 13: The material according to Paragraph 10, wherein the material has an ability of donating hydrogen atoms, is chemically inert and has thermal stability under hydrotreating operating conditions comprising a temperature range of 200-450° C. and pressures of 1-10 MPa, in presence or absence of catalyst in a batch, semi-continuous, fixed bed continuous or ebullated bed continuous reactor.

### BRIEF DESCRIPTION OF THE DRAWINGS

FIG. 1. General scheme of the polyhydroxyalkylation reaction between reactants A₂ and B₂ to obtain polymer A-B. Where R═H, CF₃, OH; R₁═CH₃, phenyl, perfluorophenyl; H—Ar—H=polyaromatic hydrocarbon, which may or may not contain aromatic heterocycles, such as naphthalene, anthracene, phenanthrene, pyrene, carbazole, among others and their substituted derivatives, or mixtures thereof.

FIG. 2. Example of the reaction scheme of the polymer synthesis related to the disclosure here disclosed, it shows the 2,2,2-trifluoroacetophenone reactant (TFAPh), the phenanthrene reactant (Phen), superacid catalyst trifluormethanesulfonic acid (TFSA), dichloromethane solvent (CH₂Cl₂) and resulting polymer (TFAPh-Phen). The reaction conditions were ambient temperature and pressure and 24 hours of reaction time.

FIG. 3. Example of the reaction scheme of the polymer synthesis related to the disclosure here disclosed, it shows the 2,2,2-trifluoroacetophenone reactant (TFAPh), the anthracene reactant (Ant), superacid catalyst trifluormethanesulfonic acid (TFSA), dichloromethane solvent (CH₂Cl₂) and resulting polymer (TFAPh-Ant). The reaction conditions were ambient temperature and pressure and 24 hours of reaction time.

FIG. 4. Example of the reaction scheme of the polymer synthesis related to the disclosure here disclosed, it shows the 2,2,2-trifluoroacetophenone reactant (TFAPh), the pyrene reactant (Pyr), superacid catalyst trifluormethanesulfonic acid (TFSA), dichloromethane solvent (CH₂Cl₂) and resulting polymer (TFAPh-Pyr). The reaction conditions were ambient temperature and pressure and 24 hours of reaction time.

FIG. 5. Thermogravimetric analysis of the solid hydrogen transfer agent SHTA-TFAPh-Phen in a temperature range from 25° C. to 800° C. with a heating rate of 2.5° C./min under air atmosphere (solid line) and inert nitrogen atmosphere (dotted line).

### DETAILED DESCRIPTION

This disclosure provides, inter alia, a method for the synthesis of polymers that have a main chain composed only of carbon-carbon bonds and structures such as naphthalene, phenanthrene, anthracene, pyrene, carbazole, or any other where two or more benzene-type aromatic rings with six carbon atoms are fused, which may or may not contain aromatic heterocycles and mixtures thereof. Additionally, the polymers obtained from the procedure described herein may or may not contain fluorine atoms in their structure. These polymers have weight average molecular weights (M_{w}) higher than polymers synthesized by conventional polycondensations (M_{w}>50000 g/mol), are chemically inert, and have a minimum decomposition temperature of 425° C. The procedure is carried out by the polyhydroxyalkylation reaction between a polycyclic aromatic compound and one with a carbonyl group in its chemical structure, such as an aldehyde, ketone, or carboxylic acid, which may or may not contain fluorine atoms in its structure, in a strong acid medium. This synthesis is performed with organochlorine solvents, such as dichloromethane and chloroform, preferably dichloromethane, strong acid catalyst, preferably trifluoromethanesulfonic acid, at low to moderate temperatures, 5-50° C., preferably 10-30° C., in an air or nitrogen atmosphere and at atmospheric pressure, under vacuum, or low pressure, 1-5 bar, preferably atmospheric pressure, for 2-36 hours, preferably 4-24 hours. The manufacturing of optimized solid hydrogen transfer agents is carried out by supporting the resulting polymers on some metallic oxide, such as alumina, silica, boehmite, among others, with the purpose of improving their mechanical, thermal, and textural properties. Subsequently, thermal treatments are applied and the complete or partial saturation of the polyaromatic units of the polymers is carried out with hydrogen gas or a hydrogen-rich gas, such as methane. The application of these optimized solid hydrogen transfer agents alone or in combination with hydrodesulfurization catalysts is an alternative to producing ultra-low sulfur diesel from the deep hydrodesulfurization of intermediate distillates through the selective hydrogenation of the most refractory sulfur compounds, in batch reactors or continuous reactors with fixed or fluidized beds.

Additionally, the solid hydrogen transfer agents obtained through the method described in this disclosure can be used alone or together with catalysts in processes for improving the properties of heavy and extra-heavy crude oils, and/or residuum from petroleum distillation, as well as in any hydrogenation or reduction reaction of organic compounds, preferably aromatic heterocyclic compounds and unsaturated hydrocarbons.

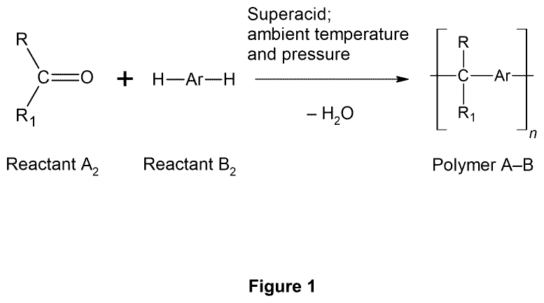

The procedure for the production of polymers subject of this disclosure is based on the methods described in the following documents: Colquhoun, H. M.; Zolotukhin, M. G.; Khalilov, L. M.; Dzhemilev, U. M. Macromolecules, 34 (4), (2001) 1122-1124; Diaz, A. M.; Zolotukhin, M. G.; Fomine, S.; Salcedo, R.; Manero, O.; Cedillo, G.; Velasco, V. M; Guzman, M. T.; Fritsch, D.; Khalizov, A. F.; Macromol. Rapid Commun., 28 (2), (2007) 183-187; Guzman-Gutierrez, M. T.; Nieto, D. R.; Fomine, S.; Morales, S. L.; Zolotukhin, M. G.; Hernandez, M. C. G.; Kricheldorf, H.; Wilks, E. S. Macromolecules, 44 (2), (2011) 194-202; Cetina-Mancilla, E.; Olvera, L. I.; Balmaseda, J.; Forster, M.; Ruiz-Treviño, F. A.; Cárdenas, J.; Vivaldo-Lima, E.; Zolotukhin, M. G. Polym. Chem., 11 (38), (2020) 6194-6205. Said polymer synthesis method is carried out by the polyhydroxyalkylation reaction, which is a polycondensation of the type A₂+B₂. This method involves the use of a reactant (A₂) that contains a carbonyl group in its structure, such as ketones, aldehydes and carboxylic acids, preferably ketones and aldehydes, and a polyaromatic reactant (B₂), such as anthracene, phenanthrene or pyrene, a chlorinated organic solvent, such as dichloromethane and chloroform, a superacid catalyst, preferably trifluoromethanesulfonic acid (TFSA), in some cases an acid co-catalyst, such as triflouroacetic acid, low and moderate temperature of 5 to 50° C., preferably of 10 to 30° C., in air or nitrogen atmosphere and atmospheric pressure, vacuum or low pressure, of 1 to 5 bar, preferably atmospheric pressure for 2 to 36 hours, preferably for 4 to 24 hours. FIG. 1 presents the general polyhydroxyalkylation reaction scheme.

Next, some examples are presented of the reactants A2, which this disclosure refers to or mixtures thereof; however, the scope of the patent is not limited to these examples:

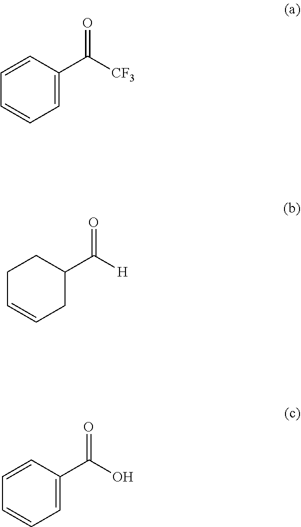 [SMILES: O=C(c1ccccc1)C(F)(F)F ; O=CC1CC=CCC1 ; O=C(O)c1ccccc1]

Next, some examples are presented of the reactants B₂, which this disclosure refers to or mixtures thereof; however, the scope of the patent is not limited to these examples:

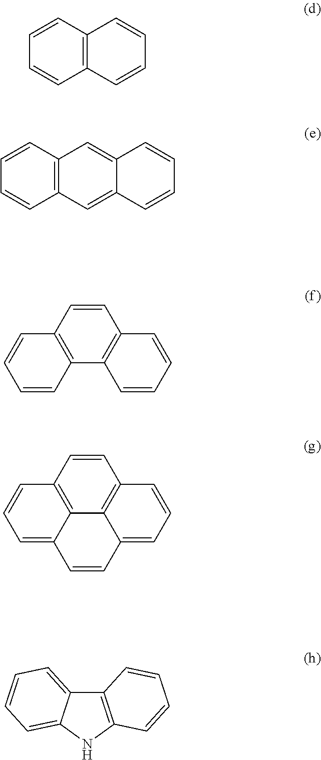

The current disclosure is not limited to the examples of reactants, solvent, superacid catalyst, or co-catalyst mentioned herein. The proportion of the B₂ and A₂ reagents can be stoichiometric, 1:1 mol, or non-stoichiometric within the range of proportions from 1:1.1 to 1:1.5 mol, respectively, preferably a non-stoichiometric ratio can improve the yield and degree of polymerization of the products, when the A₂ reagent is in excess by 1.3 times compared to the B₂ reagent. The reaction time depends on the reagents and the proportion used between them and falls within the range of 2 to 36 hours, preferably 4 to 24 hours for non-stoichiometric proportions.

The synthesis method referred to in this disclosure includes, without limitation, the following steps: 1) weigh the B₂ reactant, polyaromatic of the naphthalene, anthracene, phenanthrene, pyrene, or carbazole type, and the A₂ reagent, with a ketone, aldehyde, or carboxylic acid functional group, with a ratio in the range of 1:1 to 1:1.5 mol, preferably with a ratio of 1:1.3 mol with an excess of A₂ reagent; 2) add the A₂ and B₂ reagents to the reactor vessel; 3) add the organochlorine solvent, such as dichloromethane or chloroform, until the reagents dissolve in the solvent under stirring, preferably with a ratio in the range of 1 to 5 mL of solvent per gram of reactant, more preferably 3 mL of solvent per gram of reagents; 4) slowly add the strong acid catalyst, preferably TFSA, at a rate within the range of 6-8 mL/min, the molar ratio of the superacid catalyst with respect to the A₂ reagent is within the range of 6-10 mol of acid catalyst/mol of A₂ reagent, preferably 7-9 mol of acid catalyst/mol of A₂ reactant; 5) if a temperature increase greater than 50° C. is observed in the reaction after the acid is added, place the reactor vessel in an ice bath or maintain a temperature in the range of 5-10° C. for 30 minutes; 6) maintain continuous stirring of the reaction mixture for a time within the range of 2-36 hours, preferably in the range of 12-48 hours for non-stoichiometric reagent proportions and 4-24 hours for stoichiometric reagent proportions; finally, 7) pour the reaction mixture into an excess of methanol to terminate the reaction and precipitate the resulting polymer.

After the polymer synthesis, the solid product is purified by continuous extraction with hot methanol over a time range of 12-48 hours. If necessary, purification can also be carried out by reprecipitation. The reprecipitation methodology involves dissolving the polymer in the minimum possible amount of suitable solvent, such as chloroform, dichloromethane, tetrahydrofuran, among others. Once completely dissolved, the solution is slowly dropped into methanol, ethanol, water, or some other liquid in which the polymer is insoluble, but the solvent is miscible; the volume of methanol is determined based on the volume of solvent in a 1:5 ratio of solvent to methanol, respectively. The polymer precipitates as a fine powder, which is vacuum filtered and washed with methanol, and then the product is left to dry for 12 to 24 hours at room temperature. Once the solid is dry, it is placed in a thimble inside the Soxhlet extraction apparatus with hot methanol. The extraction time is determined visually until the hot methanol that contacts the solid polymer maintains its colorless appearance, as the reaction byproducts and polymer impurities are commonly colored. In some embodiments of the disclosure described herein, it may be necessary to perform the reprecipitation procedure two or more times to obtain high-purity polymers.

The manufacture of the supported solid hydrogen transfer agent includes forming a composite material of the base polymer along with a metallic oxide, such as boehmite (AlO(OH)), alumina (Al₂O₃), silica (SiO₂), kaolin (Al₂Si₂O₅(OH)₄), and titanium dioxide (TiO₂), or mixtures thereof. The weight ratio between the polymer and the metal oxide is 5 to 30% by weight of the polymer and 70 to 95% by weight of the metallic oxide. The obtained polymer is pulverized and sieved; afterward, it is added to a peptized gel of the metal oxide with water and 5% diluted nitric acid. The synthesized polymer is incorporated into the peptized gel through stirring, extruded in a mechanical extrusion system at a constant speed, and dried in an oven at a temperature between 9° and 130° C. for 6 to 12 hours. The process of manufacturing supported solid hydrogen transfer agents on a metallic oxide, their thermal treatment and activation, or partial or complete hydrogenation of the 6-membered aromatic rings of the polyaromatic units present in the structure of these polymers is detailed in U.S. Pat. No. 10,793,784 B2.

The solid hydrogen transfer agents, with metallic oxides or without metallic oxides, produced from the methodology related to this disclosure, can be applied in hydrotreatments, such as deep hydrodesulfurization of intermediate distillates for the production of ultra-low sulfur liquid transportation fuels, the improvement of the properties of heavy and extra-heavy crudes or petroleum distillation residues, among others. It has been observed that the use of two or more sulfide catalysts with transition metals from group VIB, preferably Mo and W, promoted by transition metals from group VIIIB, preferably Co and Ni, with different characteristics can cause a synergistic effect between them, improving hydrogenation conversion and the removal of heteroatoms from hydrocarbons, as well as moderating operational conditions and costs compared to using the catalysts separately in the same process (Leal, E.; Torres-Mancera, P.; Ancheyta, J. Energy Fuels, 36, (2022) 3201-3218). Similarly, the application of the solid hydrogen transfer agents described in this disclosure, along with one or more sulfide catalysts with transition metals from group VIB, preferably Mo and W, promoted by transition metals from group VIIIB, preferably Co and Ni, can generate a synergistic effect that improves conversion in hydrodesulfurization, hydrodenitrogenation, hydrocracking, hydrodeoxygenation, hydrodemetallation, hydrogenation, hydrocracking, and any other hydrogenation reaction in the presence of hydrogen gas, methane, or a mixture of both.

The current disclosure presents the advantages of being able to produce polymers where the main chain is composed solely of carbon-carbon bonds, which increases their chemical stability and makes them more compatible with the hydrocarbons that comprise the petroleum and its derivatives. Additionally, the polymers obtained from the procedure described here may or may not contain fluorine atoms in their structure; if fluorine atoms are present, the obtained polymers will show improved thermal stability. Furthermore, the polymer synthesis method described here, through the polyhydroxyalkylation reaction, is very flexible and allows the use of polyaromatic monomers without the need for pretreatments, for example, anthracene, phenanthrene, pyrene, carbazole, among others. Moreover, adjusting the reaction conditions (reagents, time, and amount of catalyst) allows control over the degree of cross-linking of the polymer chains and, therefore, the properties of the polymer, such as hydrogen donating ability, decomposition temperature, solubility, and mechanical properties. These characteristics of the methodology disclosed in the present disclosure are highly relevant because, due to them, hydrogen donor polymers can be easily designed and synthesized for specific applications, as not all polyaromatic polymers exhibit the same hydrogen donating ability or the same optimal conditions for the reversibility of the hydrogenation-dehydrogenation reaction. In this case, the synthesized polymers were designed to have high reaction rate constants and a greater hydrogen donating ability.

### EXAMPLES

To demonstrate some hydrogen donor polymers, the manufacture of a polymer/metallic oxide composite material and its application in the hydrodesulfurization reaction are described in the following examples.

### Example 1

### Method of Synthesis of Polymer TFAPh-Phen

In a 100 mL Erlenmeyer flask with glass stopper, 2.1201 g of phenanthrene (Phen), 2.2 mL of 2,2,2-trifluoroacetophenone (TFAPh) and 15 mL of the CH₂Cl₂ solvent were added. This mixture was stirred at room temperature (20-24° C.) until a homogeneous solution was observed. Subsequently, inside a fume hood and with proper safety equipment, 10.8 mL of TFSA were added dropwise at a moderate rate, the drip rate was controlled with a 25 mL burette. The increase in temperature was monitored during the addition of the acid, if the reaction temperature increased to more than 50° C., it would be necessary to place the flask in an ice bath. The reaction was continuously stirred under room temperature and atmospheric pressure for 24 h after the addition of the superacid catalyst. After the 24 h, stirring was stopped, and the reaction mixture was poured into a 250 mL Erlenmeyer flask filled with 100 ml of methanol to terminate the polymerization reaction, the pouring of the reaction mixture to the methanol was carried out slowly, allowing the liquid to run down the walls of the flask.

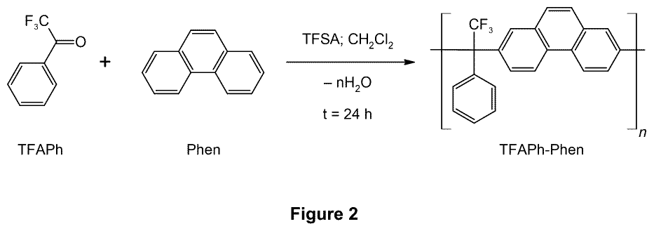

The obtained product was vacuum filtered and washed with 400 ml of methanol. The polymer was then dried at room temperature for a range of 12 to 24 hours, and the solid product was weighed. Then the solid was purified by means of the reprecipitation technique; the polymer was dissolved in the minimum amount possible of chloroform, once completely dissolved, it was added dropwise into methanol. The methanol volume was determined from the chloroform volume in a ratio of 1:5 of chloroform and methanol, respectively. The polymer precipitated in the methanol as a white powder, which was vacuum filtered and washed with methanol, subsequently, the product was then left to dry for 12 to 24 hours. Once the polymer was dry, it was placed in a cellulose thimble inside a Soxhlet extractor and the extraction was carried out with 250-400 mL of hot methanol for a time range of 12-24 h. Finally, the thimble with the obtained polymer was placed inside an oven at a temperature range of 100-130° C. for at least 4 hours, and the pure and dry obtained polymer was weighed to calculate the total yield of the reaction. In this reaction, 3.87 g of the TFAPh-Phen polymer were obtained. FIG. 2 shows the polymerization reaction and the structure of the obtained TFAPh-Phen polymer (A-B) in this example.

The attenuated total reflectance-Fourier transformed infrared spectroscopy characterization technique was carried out to the TFAPh-Phen powder and the characteristic signals of the polymer were assigned to the molecular vibrations of the corresponding bonds. Signals around 3000 cm⁻¹ correspond to the stretching of the aromatic C—H bonds, the signal at 1451, 1492 and 1603 cm⁻¹ correspond to the stretching of the aromatic C═C double bonds, the signal at 1233 cm⁻¹ corresponds to the deformation of the aromatic rings, the band at a wavenumber of 1144 cm⁻¹ was assigned to the stretching of the C—F bonds, and the deformation of the C—H bonds in aromatic compounds was assigned to the signal at 840 cm⁻¹.

The average molecular weight of the TFAPh-Phen polymer was determined by the size exclusion chromatography technique. The number average molecular weight (Mₙ) obtained was 18392 g/mol, the weight average molecular weight (M_{w}) obtained was 95529 g/mol, and the polydispersity index was equal to 5.2.

The spectroscopic characterization techniques of nuclear magnetic resonance of hydrogen (¹H) and carbon (¹³C) were performed. For the nuclear magnetic resonance of hydrogen, the following chemical shifts (δ, ppm) were obtained: 7.017, 7.113, 7.278, 7.574, 8.0055, 8.349 and 8.496 ppm. For the nuclear magnetic resonance of carbon, the following chemical shifts (δ, ppm) were obtained: 122.587, 122.839, 124.270, 124.788, 126.765, 127.147, 128.238, 128.358, 129.640, 130.022, 131.355 and 131.831 ppm.

The thermogravimetric analysis of the TFAPh-Phen polymer was conducted in the temperature range of 25-500° C. and with a heating rate of 2.5° C./min under air and nitrogen atmospheres. The decomposition temperature of the TFAPh-Phen polymer was determined through the first derivative analysis of the obtained curve and had a result of 475° C. under air atmosphere and 482° C. under nitrogen atmosphere. Therefore, it is considered that under the hydrodesulfurization operating conditions of medium severity: hydrogen pressure in the range of 35-56 kg/cm² and temperature in the range of 320-350° C., the obtained polymer is expected to remain stable.

### Example 2

### Method of Synthesis of Polymer TFAPh-Ant

In a 100 mL Erlenmeyer flask with glass stopper, 2.1277 g of anthracene (Ant), 2.2 mL of 2,2,2-trifluoroacetophenone (TFAPh) and 15 mL of the CH₂Cl₂ solvent were added. This mixture was stirred at room temperature (20-24° C.) until a homogeneous solution was observed. Subsequently, inside a fume hood and with proper safety equipment, 10.8 mL of TFSA were added dropwise at a moderate rate, the drip rate was controlled with a 25 mL burette. The increase in temperature was monitored during the addition of the acid, if the reaction temperature increased to more than 50° C., it would be necessary to place the flask in an ice bath. The reaction was continuously stirred under room temperature and atmospheric pressure for 24 h after the addition of the superacid catalyst. After the 24 h, stirring was stopped, and the reaction mixture was poured into a 250 mL Erlenmeyer flask filled with 100 ml of methanol to terminate the polymerization reaction, the pouring of the reaction mixture to the methanol was carried out slowly, allowing the liquid to run down the walls of the flask.

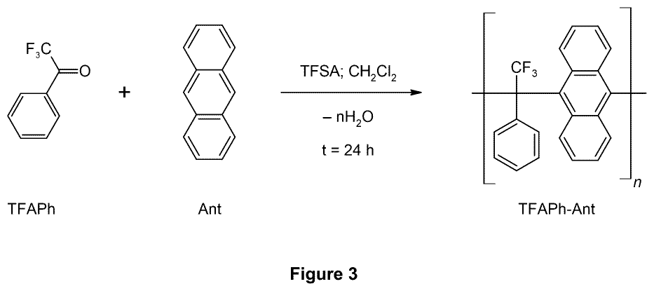

The obtained product was vacuum filtered and washed with 400 ml of methanol. The polymer was then dried at room temperature for a range of 12 to 24 hours, and the solid product was weighed. Then the solid was purified by means of the reprecipitation technique; the polymer was dissolved in the minimum amount possible of chloroform, once completely dissolved, it was added dropwise into methanol. The methanol volume was determined from the chloroform volume in a ratio of 1:5 of chloroform and methanol, respectively. The polymer precipitated in the methanol as a white powder, which was vacuum filtered and washed with methanol, subsequently, the product was then left to dry for 12 to 24 h. Once the polymer was dry, it was placed in a cellulose thimble inside a Soxhlet extractor and the extraction was carried out with 250-400 mL of hot methanol for a time range of 12-24 h. Finally, the thimble with the obtained polymer was placed inside an oven at a temperature range of 100-130° C. for at least 4 hours, and the pure and dry obtained polymer was weighed to calculate the total yield of the reaction. In this reaction, 1.67 g of the TFAPh-Ant polymer were obtained. FIG. 3 shows the polymerization reaction and the structure of the obtained TFAPh-Ant polymer (A-B) in this example.

The attenuated total reflectance-Fourier transformed infrared spectroscopy characterization technique was carried out to the TFAPh-Ant powder and the characteristic signals of the polymer were assigned to the molecular vibrations of the corresponding bonds. Signals around 3058 cm⁻¹ correspond to the stretching of the aromatic C—H bonds, the signal at 1454 and 1622 cm⁻¹ correspond to the stretching of the aromatic C═C double bonds, the signal at 1257 cm⁻¹ corresponds to the deformation of the aromatic rings, the band at a wavenumber of 1154 cm⁻¹ was assigned to the stretching of the C—F bonds, and the deformation of the C—H bonds in aromatic compounds was assigned to the signal at 877 cm⁻¹.

The average molecular weight of the TFAPh-Ant polymer was determined by the size exclusion chromatography technique. The number average molecular weight (Mₙ) obtained was 43377 g/mol, the weight average molecular weight (M_{w}) was 79189 g/mol, and the polydispersity index was equal to 1.8.

The spectroscopic characterization techniques of nuclear magnetic resonance of hydrogen (¹H) and carbon (¹³C) were performed to the TFAPh-Ant polymer. For the nuclear magnetic resonance of hydrogen, the following chemical shifts (δ, ppm) were obtained: 4.325, 4.712, 6.715, 7.317, 7.557, 8.025, 8.344, 9.046 and 9.220 ppm. For the nuclear magnetic resonance of carbon, the following chemical shifts (δ, ppm) were obtained: 123.085, 123.490, 125.280, 125.676, 126.131, 127.131, 127.455, 128.135, 128.613, 128.941, 129.059, 129.956, 131.634, 132.083 and 132.502 ppm.

The thermogravimetric analysis of the TFAPh-Ant polymer was conducted in the temperature range of 25-800° C. and with a heating rate of 2.5° C./min under air and nitrogen atmospheres. The decomposition temperature of the TFAPh-Ant polymer was determined through the first derivative analysis of the obtained curve and had a result of 444° C. under air atmosphere and 468° C. under nitrogen atmosphere. Therefore, it is considered that under the hydrodesulfurization operating conditions of medium severity: hydrogen pressure in the range of 35-56 kg/cm² and temperature in the range of 320-350° C., the obtained polymer is expected to remain stable.

### Example 3

### Method of Synthesis of Polymer TFAPh-Pyr

In a 100 mL Erlenmeyer flask with glass stopper, 2.3899 g of pyrene (Pyr), 2.2 mL of 2,2,2-trifluoroacetophenone (TFAPh) and 15 mL of the CH₂Cl₂ solvent were added. This mixture was stirred at room temperature (20-24° C.) until a homogeneous solution was observed. Subsequently, inside a fume hood and with proper safety equipment, 10.8 mL of TFSA were added dropwise at a moderate rate, the drip rate was controlled with a 25 mL burette. The increase in temperature was monitored during the addition of the acid, if the reaction temperature increased to more than 50° C., it would be necessary to place the flask in an ice bath. The reaction was continuously stirred under room temperature and atmospheric pressure for 24 h after the addition of the superacid catalyst. After the 24 h, stirring was stopped, and the reaction mixture was poured into a 250 mL Erlenmeyer flask filled with 100 mL of methanol to terminate the polymerization reaction, the pouring of the reaction mixture to the methanol was carried out slowly, allowing the liquid to run down the walls of the flask.

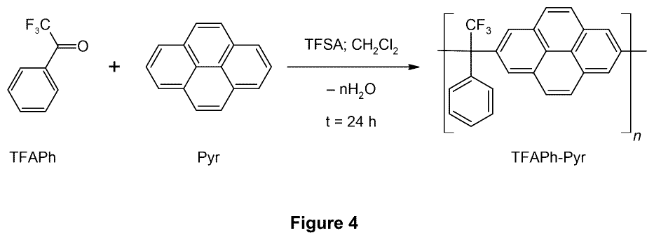

The obtained product was vacuum filtered and washed with 400 ml of methanol. The polymer was then dried at room temperature for a range of 12 to 24 hours, and the solid product was weighed. Then the solid was purified by means of the reprecipitation technique; the polymer was dissolved in the minimum amount possible of chloroform, once completely dissolved, it was added dropwise into methanol. The methanol volume was determined from the chloroform volume in a ratio of 1:5 of chloroform and methanol, respectively. The polymer precipitated in the methanol as a white powder, which was vacuum filtered and washed with methanol, subsequently, the product was then left to dry for 12 to 24 h. Once the polymer was dry, it was placed in a cellulose thimble inside a Soxhlet extractor and the extraction was carried out with 250-400 mL of hot methanol for a time range of 12-24 h. Finally, the thimble with the obtained polymer was placed inside an oven at a temperature range of 100-130° C. for at least 4 hours, and the pure and dry obtained polymer was weighed to calculate the total yield of the reaction. In this reaction, 1.77 g of the TFAPh-Pyr polymer were obtained. FIG. 4 shows the polymerization reaction and the structure of the obtained TFAPh-Pyr polymer (A-B) in this example.

The attenuated total reflectance-Fourier transformed infrared spectroscopy characterization technique was carried out to the TFAPh-Pyr polymer powder and the characteristic signals of the polymer were assigned to the molecular vibrations of the corresponding bonds. Signals around 3032 cm⁻¹ correspond to the stretching of the aromatic C—H bonds, the signal at 1454, 1498 and 1604 cm⁻¹ correspond to the stretching of the aromatic C═C double bonds, the signal at 1260 cm⁻¹ corresponds to the deformation of the aromatic rings, the band at a wavenumber of 1154 cm⁻¹ was assigned to the stretching of the C—F bonds, and the deformation of the C—H bonds in aromatic compounds was assigned to the signal at 844 cm⁻¹.

The average molecular weight of the TFAPh-Pyr polymer was determined by the size exclusion chromatography technique. The number average molecular weight (Mₙ) obtained was 91498 g/mol, the weight average molecular weight (M_{w}) was 176460 g/mol, and the polydispersity index was equal to 1.9.

The spectroscopic characterization techniques of nuclear magnetic resonance of hydrogen (¹H) and of carbon (¹³C) were performed to the TFAPh-Pyr polymer. For the ¹H NMR, the following chemical shifts (δ, ppm) were obtained: 5.870, 7.284, 8.176, 8.223 and 8.814 ppm. For the ¹³C NMR, the following chemical shifts (δ, ppm) were obtained: 122.660, 125.748, 128.129, 128.860, 129.499, and 135.823 ppm.

The thermogravimetric analysis of the TFAPh-Pyr polymer was conducted in the temperature range of 25-800° C. and with a heating rate of 2.5° C./min under air and nitrogen atmospheres. The decomposition temperature of the TFAPh-Pyr polymer was determined through the first derivative analysis of the obtained curve and had a result of 436° C. under air atmosphere and 442° C. under nitrogen atmosphere. Therefore, it is considered that under the hydrodesulfurization operating conditions of medium severity: hydrogen pressure in the range of 35-56 kg/cm² and temperature in the range of 320-350° C., the obtained polymer is expected to remain stable.

### Example 4

### Procedure of Manufacturing, Thermal Treatment and Activation of the Solid Hydrogen Transfer Agent with the TFAPh-Phen Polymer (SHTA-TFAPh-Phen)

### a) Manufacturing of SHTA-TFAPh-Phen

The SHTA-TFAPh-Phen composite was fabricated with a weight ratio of 20% TFAPh-Phen polymer and 80% Al₂O₃. 4.7064 g of boehmite, which acts as a precursor for 4.0000 g of Al₂O₃, and 1.0005 g of the TFAPh-Phen polymer were weighed. 5.2 mL of deionized water were added and mixed with the boehmite until a paste was formed, followed by another additional 1.3 mL of water. Subsequently, the mixture was peptized by adding 2.8 mL of 5% HNO₃ and continuously stirred until a gel was formed. After, the TFAPh-Phen polymer was gradually incorporated into the peptized boehmite mixture, ensuring homogeneous dispersion of the polymer. The resulting gel must be homogenous and extrudable. It was then loaded into a 20 mL syringe, extruded into long strips, and dried for 12-24 h. After, the strips were then cut into pieces approximately 1 cm long. Finally, said extrudates were placed in porcelain dishes for drying for at least 4 hours in an oven at temperature range between 10° and 120° C. 5.06 g were obtained of the dried SHTA-TFAPh-Phen.

### b) Thermal Treatment (Curing) of SHTA-TFAPh-Phen

A sample of 2.1056 g of SHTA-TFAPh-Phen were placed in a glass continuous-flow micro-reactor. The nitrogen flow rate of 100-130 mL/min was set and the sample was heated from 15-30° C. up to a range of 140-160° C. The temperature was held for a range of 30-40 min and then the temperature of the micro-reactor was increased to 380-400° C., the oven remained at this temperature for 3-5 hours with a constant nitrogen gas flow. After completing the thermal treatment (curing), the heating was turned off and the nitrogen flow was maintained until the temperature inside the micro-reactor was equal to a range of 15-30° C.

### c) Activation (Hydrogenation) of SHTA-TFAPh-Phen

1.6787 g of cured ATHS TFAF-Fen were introduced into a glass micro-reactor. The nitrogen flow was set at a range of 100-130 mL/min and the sample was heated from a temperature range of 15-30° C. to a range of 140-160° C. The temperature was maintained at a temperature range of 140-160° C. for 30-40 min and then the nitrogen flow was changed to hydrogen at a rate in the range of 100-130 mL/min and the micro-reactor was heated to a temperature of 380-400° C. and the furnace was maintained for 3-5 hours at a constant hydrogen flow. Then the temperature was lowered to a temperature range of 320-375° C. and maintained for another 1-2 h. Subsequently, the heating was turned off and the flow was changed back from hydrogen to nitrogen at a rate in the range of 80-100 mL/min, until the temperature inside the micro-reactor was equal to the temperature in the range of 15-30° C.

### d) Characterization of SHTA-TFAPh-Phen

The spectroscopic characterization of attenuated total reflectance-Fourier transformed infrared spectroscopy of SHTA-TFAPh-Phen was performed on curated and activated SHTA-TFAPh-Phen powders. In the case of the fresh SHTA-TFAPh-Phen, no characteristic signals of the TFAPh-Phen polymer were observed, the only bands distinguished were the stretching of O—H bonds at 3450 cm⁻¹ and the bending of H—O—H bonds at 1635 cm⁻¹, both attributed to the boehmite support. The spectrum of the activated SHTA-TFAPh-Phen showed the characteristic signals of the TFAPh-Phen polymer. The signal at 3100 cm⁻¹ was assigned to the stretching of aromatic C—H bonds, the signal at 1226 cm⁻¹ corresponded to the deformation of aromatic rings, and a band at 1144 cm⁻¹ was identified, corresponding to the stretching of C—F bonds. Additionally, other signals due to the boehmite support were observed: at 1388 cm⁻¹ nitrate (NO₃⁻) vibrations, 1074 cm⁻¹ Al—OH bond bending, and 430 cm⁻¹ Al⁺³ with octahedral geometry.

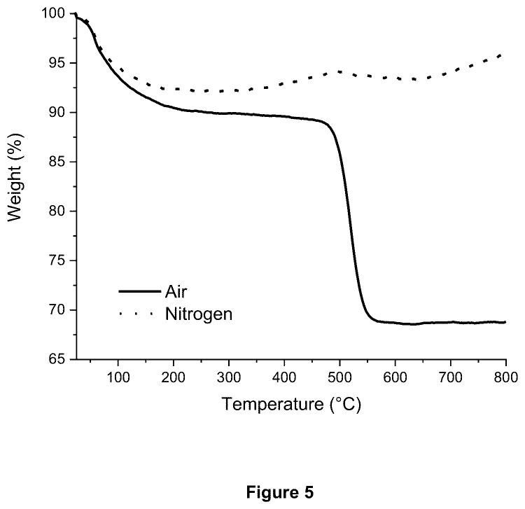

Thermogravimetric analysis and differential scanning calorimetry were performed on the activated SHTA-TFAPh-Phen. The analyses were performed with a heating rate of 2.5° C./min from 25° C. to 800° C., under air and nitrogen atmospheres. In the case of the SHTA-TFAPh-Phen under air atmosphere, two significant weight losses were observed. The first weight loss corresponds to the loss of surface and crystallization water molecules (between 70° C. and 300° C.; −10.08 wt. %), and the second one was related to the combustion of the TFAPh-Phen polymer (between 474° C. and 548° C.; −21.14 wt. %). In the TGA-DSC of the activated SHTA-TFAPh-Phen under nitrogen atmosphere, only one weight loss was observed, which is attributed to the loss of surface and crystallization water molecules (between 70° C. and 300° C.; −7.06 wt. %). No decomposition of the TFAPh-Phen polymer was detected within the temperature range of 25-800° C. under N₂ atmosphere. Therefore, in both air and inert nitrogen atmospheres, the polymers are thermally stable up to at least 450° C. The comparison of the TGA spectra of SHTA-TFAPh-Phen, under air and nitrogen atmospheres, are shown in FIG. 5.

### Example 5

### Hydrotreating of a Partially Hydrotreated Gas Oil in a Batch Reactor with a Hydrodesulfurization Catalyst

The hydrodesulfurization evaluation of a catalyst was carried out in a 0.5 L capacity autoclave reactor. Prior to the evaluation, 2.5 g of the catalyst were activated in a continuous flow reactor, where a flux of a mixture of hydrogen and hydrogen sulfide gases was supplied with the objective of sulfhydrate the catalyst at a temperature range of 300 to 450° C. for 3 to 6 h.

In the hydrodesulfurization evaluation in the autoclave reactor a partially hydrotreated straight-run gas oil was used. The elemental composition of the partially hydrotreated straight-run gas oil used was the following: 86.10 wt. % of carbon, 13.70 wt. % of hydrogen, 0.0063 wt. % of nitrogen and 0.189 wt. % of sulfur; and a specific weight of 0.8449 g/cm³ at 20/4° C.

250.0 g of the partially hydrotreated straight-run gas oil were added to the reactor vessel, then 2.5 g of the activated catalyst were added. Afterward, the reactor was closed and the initial pressure was set at 28.6 kg/cm² of hydrogen. Once the reactor was loaded and sealed, the heating started until 350° C. with a stirring rate of 750 rpm. The pressure inside the reactor at this temperature during the reaction was 55.1 kg/cm² and the reaction lasted 4 h. Once the reaction finished, the samples of the gas product were collected to perform its chromatographic analysis and the liquid product was separated from the spent catalyst for its characterization.

The elemental analysis was performed to the liquid product; the following results were obtained: 86.04 wt. % of carbon, 13.85 wt. % of hydrogen, 0.0066 wt. % of nitrogen and 0.097 wt. % of sulfur. Which means that a hydrodesulfurization percentage of 48.68% was obtained with the catalyst alone.

### Example 6

### Hydrotreating of a Partially Hydrotreated Gas Oil in a Batch Reactor with a Hydrodesulfurization Catalyst and SHTA-TFAPh-Phen

The hydrodesulfurization evaluation of the activated SHTA-TFAPh-Phen and a catalyst was carried out in a 0.5 L capacity autoclave reactor. Prior to the evaluation, 1.25 g of the catalyst were activated in a continuous flow reactor, where a flux of a mixture of hydrogen and hydrogen sulfide gases was supplied with the objective of sulfhydrate the catalyst at a temperature range of 300-450° C. for 3-6 h.

In the hydrodesulfurization evaluation in the autoclave reactor a partially hydrotreated straight-run gas oil was used. The elemental composition of the partially hydrotreated straight-run gas oil used was the following: 86.10 wt. % of carbon, 13.70 wt. % of hydrogen, 0.0063 wt. % of nitrogen and 0.189 wt. % of sulfur; and a specific weight of 0.8449 g/cm³ at 20/4° C.

250.1 g of the partially hydrotreated straight-run gas oil were added to the reactor vessel, then 1.25 g of the activated SHTA-TFAPh-Phen and 1.25 g of the activated catalyst were added. Afterward, the reactor was closed and the initial pressure was set at 28.6 kg/cm² of hydrogen.

Once the reactor was loaded and sealed, the heating started until 350° C. with a stirring rate of 750 rpm. The pressure inside the reactor at this temperature during the reaction was 55.1 kg/cm² and the reaction lasted 4 h. Once the reaction finished, the samples of the gas product were collected to perform its chromatographic analysis and the liquid product was separated from the spent catalyst for its characterization.

The elemental analysis was performed to the liquid product; the following results were obtained: 86.06 wt. % of carbon, 13.84 wt. % of hydrogen, 0.0058 wt. % of nitrogen and 0.090 wt. % of sulfur. Which means that a hydrodesulfurization percentage of 52.38% was obtained. The hydrodesulfurization percentage obtained while employing 1.25 g of catalyst along with 1.25 g of SHTA-TFAPh-Phen was higher than while using 2.5 g of catalyst.

1. A method for synthesis of polymers for manufacturing of solid hydrogen transfer agents, said method comprising:
Step 1: weighing a first compound comprising a polycyclic aromatic compound and a second compound comprising a compound with a ketone, aldehyde or carboxylic acid functional group that may or may not contain fluorine atoms in its structure, with a ratio in the range of 1:1-1:1.5 mol with an excess of the second compound with a ketone, aldehyde or carboxylic acid functional group;
Step 2: adding the first and second compounds of step 1 as reactants to a reactor vessel;
Step 3: adding an organochlorinated solvent and continuously stirring until the reactants are dissolved, thereby yielding a reaction mixture of Step 3, wherein the organochlorinated solvent is selected from the group consisting of dichloromethane and chloroform, wherein the organochlorinated solvent is added in a ratio in the range of 1 mL-5 mL of solvent per gram of reactants, or in a ratio of 3 mL of solvent per gram of reactants;
Step 4: adding a strong acid catalyst, wherein the strong acid catalyst may optionally comprise a superacid catalyst selected from the group consisting of trifluoromethanesulfonic acid and trifluoroacetic acid, to the reaction mixture of Step 3 under stirring, at low to moderate temperatures, 5-50° C., preferably 10-30° C., under air or nitrogen atmosphere and at atmospheric, vacuum or low pressure, 1-5 bar, preferably atmospheric pressure, thereby yielding a reaction mixture of Step 4;
Step 5: maintaining continuous stirring of the reaction mixture of Step 4 for a time in the range of 2-48 hours, preferably 12-36 hours for non-stoichiometric reagent proportions and 4-24 hours for stoichiometric reagent proportions, thereby yielding a reaction mixture of Step 5;
Step 6: pouring the reaction mixture of Step 5 into methanol under continuous stirring, wherein the methanol volume is in excess, in a range of ratios of 5:1 to 20:1 in proportion to the solvent to terminate the reaction and precipitate the resulting polymer to yield a solid polymer;
Step 7: filtrating the solid polymer at vacuum and washing with methanol, and subsequently leaving it to dry for 12 to 24 hours at room temperature; and
Step 8: purifying the solid polymer by means of extraction with hot methanol in continuous reflux at boiling point temperature for 12 to 48 hours.

2. The method according to claim 1, characterized by having weight average molecular weights higher than 50000 g/mol, chemically inert, minimum decomposition temperature of 425° C., and a main chain composed only by carbon-carbon bonds, which contain chemical structures of the type of naphthalene, phenanthrene, anthracene, pyrene or any other where two or more aromatic rings of six carbon atoms of the benzene type are fused, which may or may not contain aromatic heterocycles; additionally, the synthesized polymers may or may not contain fluorine atoms in their structure.

3. The method according to claim 1, wherein the synthesized polyaromatic polymer has a main polymeric chain of carbon-carbon bonds free of ester, ether, amide, sulfone, among other functional groups with heteroatoms.

4. The method according to claim 1, wherein in Step 1, the polycyclic aromatic compound is a polyaromatic hydrocarbon, which may or may not contain aromatic heterocycles selected from the group consisting of naphthalene, anthracene, phenanthrene, pyrene and carbazole and their substituted derivatives, or mixtures thereof.

5. The method according to claim 1, wherein in Step 1, the compound with a carbonyl group in its chemical structure is an organic compound with at least one functional group of ketone, aldehyde or carboxylic acid, and do not contain fluorine atoms in its structure, said organic compound optionally being selected from the group consisting of benzaldehyde, 3-cyclohexene-1-carboxaldehyde, benzoic acid and their substituted derivatives, or mixtures thereof.

6. The method according to claim 1, wherein in Step 1, the compound with a carbonyl group in its chemical structure is an organic compound with at least one functional group of ketone, aldehyde or carboxylic acid, and contains fluorine atoms in its structure, said organic compound optionally being selected from the group consisting of 2,2,2-trifluoroacetophenone, fluoroacetone, hexafluoroacetone, 1,1,1-trifluoroacetone, and their substituted derivatives, or mixtures thereof; and therefore, show improved thermal stability.

7. The method according to claim 1, wherein in Step 1, the polycyclic aromatic compound is in a range of proportions with the compound with carbonyl group of 1:1 to 1:1.5 in mol, respectively, or 1:1.2 to 1:1.4 in mol, respectively.

8. The method according to claim 1, wherein in Step 4, the strong acid catalyst is optionally a superacid selected from the group consisting of trifluoromethanesulfonic acid, trifluoroacetic acid, sulfuric acid and methanesulfonic acid, or mixture thereof.

9. The method according to claim 1, wherein in Step 8, the purification of the solid polymer is by means of the continuous extraction with hot methanol, ethanol, or acetone, among others, for a time range of 12 to 48 hours, additionally involving one or more reprecipitations with a adequate pair of solvents selected from the group consisting of chloroform, dichloromethane, tetrahydrofuran, and mixtures thereof, and methanol, ethanol, and mixtures thereof.

10. A material of a solid hydrogen transfer agent type containing one or more of the polymers synthesized by the method according to claim 1.

11. The material according to claim 10, wherein said material may or may not be supported over metallic oxides, and may be used alone or in combination with catalysts in hydrotreating processes of crude oil and/or any of the fraction and derivatives obtained from it, as well as in any hydrogenation reaction or reduction of organic compounds.

12. The material according to claim 11, wherein the metallic oxides are selected from the group consisting of alumina, boehmite, silica, titania, kaolin and mixtures thereof.

13. The material according to claim 10, wherein the material has an ability of donating hydrogen atoms, is chemically inert and has thermal stability under hydrotreating operating conditions comprising a temperature range of 200-450° C. and pressures of 1-10 MPa, in presence or absence of catalyst in a batch, semi-continuous, fixed bed continuous or ebullated bed continuous reactor.
